(19) United States
(12) Patent Application Publication
(10) Pub. No.: US 2005/0079813 A1
(43) Pub. Date: Apr. 14, 2005

(54) Method and means for stuffing natural casings with a sausage emulsion

(75) Inventors: Steven P. Hergott, West Des Moines, IA (US); David S. Hamblin, Norwalk, IA (US); Michael J. Hardy, West Des Moines, IA (US)

Correspondence Address: ZARLEY LAW FIRM P.L.C., CAPITAL SQUARE, 400 LOCUST, SUITE 200, DES MOINES, IA, 50309-2350, US

(73) Assignee: Townsend Engineering Company, Des Moines, IA (US)

(21) Appl. No.: 10/659,409

(22) Filed: Sep. 10, 2003

(51) Int. Cl. A22C 11/00

(52) U.S. Cl. 452/31

(57) ABSTRACT

A method of stuffing natural casings with emulsion involves placing a textured continuous belt transversely with respect to a longitudinal axis of a stuffing tube. The textured belt engages with the natural casing on the stuffing tube and distributes a compressive force on the outer surface of the casing. The textured belt then rotates to advance the natural casing into engagement with a twisting mechanism, which is downstream of the stuffing tube and prepares the casing for linking. The textured belt ensures that the natural casing is evenly fed into the twisting mechanism. A machine includes the foregoing components to accomplish the method.

### BACKGROUND OF THE INVENTION

Traditionally, sausages have been made by filling the natural intestines of sheep or other animals with a sausage product whereupon the filled natural casing was formed into links for cooking. In more modern times, sausages are predominantly made by introducing an emulsion into an artificial casing, which encases the sausage material through linking and preliminary cooking. Machines for making sausages with artificial casings have a high volume capability (up to 30,000 sausages per hour). Efforts have been made to use these high-speed machines with natural casings. However, because of the nature of the natural casings including their relatively shorter and variable length and non-uniform diameter, modern sausage encasing machines have not achieved the volume and capacity with natural casings as they do with artificial casings.

U.S. Pat. No. 6,585,580 to Hergott et al. discloses a method and means for stuffing natural casings with sausage emulsion. Hergott et al. teaches the use of a slidable collar 28 that works in conjunction with a sensor 24A to position a natural casing 32 about the stuffing tube 14. As the natural casing 32 is stuffed with emulsion, collar 28 advances the natural casing 32 towards the twisting mechanism 16, which prepares the natural casing 32 for linking.

One disadvantage with conventional methods of stuffing natural casings with sausage emulsion, such as that taught by Hergott et al. above, is that the natural casing, as it is being stuffed with emulsion, does not easily advance towards the twisting mechanism. Typical methods will push the natural casing towards the twisting mechanism, which may cause the natural casing to become shirred as it approaches the twisting mechanism.

It is therefore a principal object of this invention to provide a method and a machine for encasing sausages whereby the natural casing is uniformly shaped when stuffed with the sausage emulsion.

A further object of this invention is to provide a method and a machine for encasing sausages whereby the natural casing is moved longitudinally on the stuffing tube by a textured belt mounted adjacent to the stuffing tube.

These and other objects will be apparent to those skilled in the art.

### BRIEF SUMMARY OF THE INVENTION

A method of stuffing natural casings with emulsion involves placing a textured continuous belt transversely with respect to a longitudinal axis of a stuffing tube. The textured belt engages with the natural casing on the stuffing tube and distributes a compressive force on the outer surface of the casing. The textured belt then rotates to advance the natural casing into engagement with a twisting mechanism, which is downstream of the stuffing tube and prepares the casing for linking. The textured belt ensures that the natural casing is evenly fed into the twisting mechanism.

A machine includes the foregoing components to accomplish the method.

### BRIEF DESCRIPTION OF THE DRAWINGS

FIG. 1 is a plan view of a sausage making machine showing the conventional components, as modified by this invention;

FIG. 2 is a partial side view of the present invention showing the forward end of the stuffing tube and the textured belt assembly adjacent the twisting mechanism.

### DESCRIPTION OF THE INVENTION

The term “emulsion” as used herein includes meat or any other edible substance.

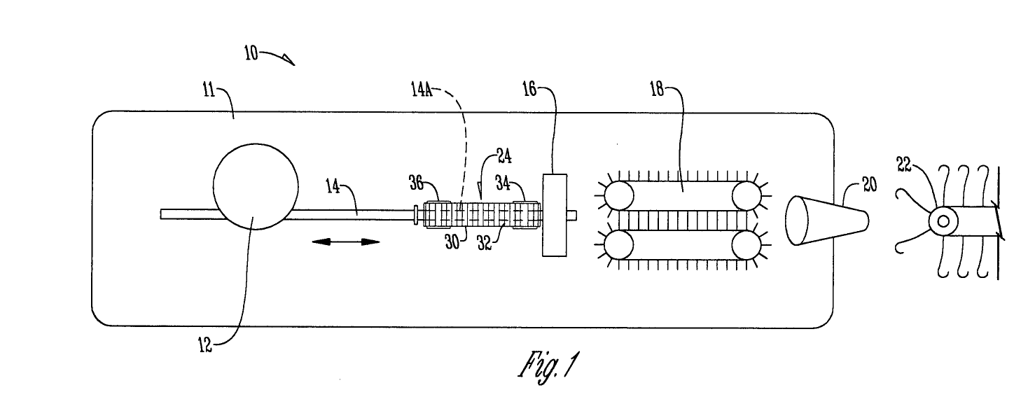

With reference to FIG. 1, a conventional sausage making machine 10 has a frame 11, a pump 12 connected to a source of emulsion (not shown), a hollow meat stuffing tube 14 with discharge end 14A, a twisting mechanism 16, a linking mechanism 18, a discharge horn 20, and a conveyor 22.

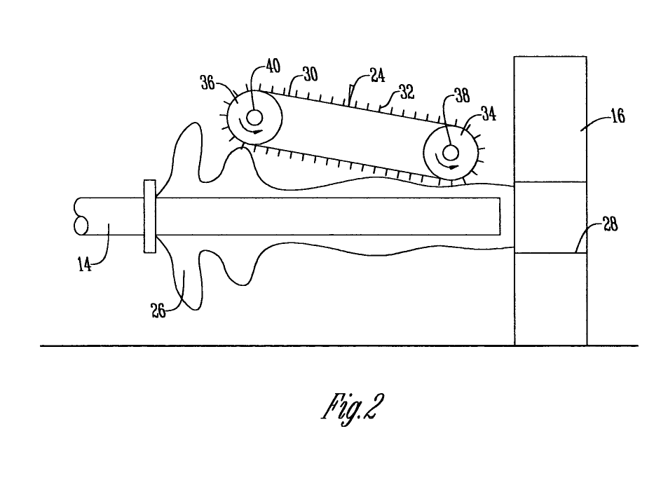

With reference to FIGS. 1 and 2, a textured belt assembly 24 is disclosed which rotates to advance natural casing 26 about stuffing tube 14. Textured belt assembly 24 is mounted adjacent and parallel to the stuffing tube 14. Textured belt assembly 24 moves casing 26 past discharge end 14A of stuffing tube 14 and through inner bore 28 of twisting mechanism 16.

Textured belt assembly 24 includes a continuous belt 30 with a plurality of grooves 32. Continuous belt 30 loops around rollers 34 and 36. Roller 34 rotates about axle 38, and roller 36 rotates about axle 40. Axles 38 and 40 may be fixed such that rollers 34 and 36 and, therefore, continuous belt 30 remain in the same position relative to the stuffing tube 14. Alternatively, axle 40 may not be fixed, allowing textured belt assembly 24 to rotate about axle 38. Textured belt assembly 24 is driven by a servo motor (not shown), as is common in the art.

In operation, grooves 32 of the continuous belt 30 engage with the outer surface of natural casing 26. Through this engagement, textured belt assembly 24 can move casing 26 towards twisting mechanism 16. Specifically, the counterclockwise rotation of rollers 34 and 36 drive continuous belt 30 in a counterclockwise direction. Grooves 32 engage with casing 26, advancing it towards twisting mechanism 16. Textured belt assembly 24 moves natural casing 26 beyond discharge end 14A, where sausage emulsion is injected into the casing 26. Textured belt assembly 24 then drives filled casing 26 through inner bore 28 of twisting mechanism 16. Where axle 40 is not fixed, textured belt assembly 24 can rotate about axle 38. As such, the roller 36 is free to follow the height with respect to stuffing tube 14 dictated by the thickness of shirred natural casing 26.

It is therefore seen that by the use of a textured belt, this invention permits the smooth advancement of natural casings about the stuffing tube and towards the twisting mechanism during the emulsion stuffing process.

1. A method of advancing a natural casing along the length of a hollow meat stuffing tube towards a twisting mechanism, comprising,
placing a hollow natural casing on the outside surface of a hollow stuffing tube having a meat emulsion discharge end,
placing a textured continuous belt adjacent and parallel to the stuffing tube in engagement with the casing on the stuffing tube, and compressively forcing the casing into engagement with an outside surface of the stuffing tube, and
rotating the textured continuous belt to slide the casing towards the discharge end of the stuffing tube and into the twisting mechanism.

2. A machine for stuffing natural casings with emulsion, comprising,
a hollow meat stuffing tube positioned adjacent a twisting mechanism on the machine having a first end and a discharge end for extruding emulsion into a natural casing on an outer surface of the stuffing tube, and
a textured belt assembly mounted adjacent and parallel to the stuffing tube near the discharge end and having a continuous belt with a plurality of grooves that loops around a pair of rollers, wherein the textured belt assembly longitudinally moves the casing about the stuffing tube and towards the discharge end and into the twisting mechanism.

3. The machine of claim 2 wherein the rollers are mounted on fixed axles.

4. The machine of claim 2 wherein only one of the rollers is mounted on a fixed axle such that the textured belt assembly is free to pivot about the fixed axle.

5. A method of advancing a natural casing along the length of a hollow meat stuffing tube towards a twisting mechanism, comprising,
placing a hollow natural casing on the outside surface of a hollow stuffing tube having a top surface and a meat emulsion discharge end,
placing a textured continuous belt adjacent and only above the top surface of the stuffing tube in engagement with the casing on the stuffing tube, and compressively forcing the casing into engagement with an outside surface of the stuffing tube, and
rotating the textured continuous belt to slide the casing towards the discharge end of the stuffing tube and into the twisting mechanism.

6. A machine for stuffing natural casings with emulsion, comprising,
a hollow meat stuffing tube having a top surface positioned adjacent a twisting mechanism on the machine having a first end and a discharge end for extruding emulsion into a natural casing on an outer surface of the stuffing tube, and
a textured belt assembly mounted adjacent and only above the top surface of the stuffing tube near the discharge end and having a continuous belt with a plurality of grooves that loops around a pair of rollers, wherein the textured belt assembly longitudinally moves the casing about the stuffing tube and towards the discharge end and into the twisting mechanism.
